(19) United States
(12) Patent Application Publication
(10) Pub. No.: US 2024/0385016 A1
(43) Pub. Date: Nov. 21, 2024

(54) SECURING PART FOR A HOUSING AND HOUSING FOR A FIELD DEVICE

(71) Applicant: Endress+Hauser Flowtec AG, Reinach (CH)

(72) Inventors: Björn Larsson, Birsfelden (CH); David Schöne, Basel (CH)

(21) Appl. No.: 18/690,768

(22) PCT Filed: Aug. 19, 2022
(86) PCT No.: PCT/EP2022/073138

§ 371 Date: Mar. 11, 2024

(30) Foreign Application Priority Data
Sep. 10, 2021 (DE) 10 2021 123 444.1

(51) Int. Cl. G01D 11/24; F16B 21/04

(52) U.S. Cl. CPC G01D 11/245; F16B 21/04

(57) ABSTRACT

A securing part for a housing is ring-shaped and extends around a longitudinal axis, wherein the securing part has a first edge and a second edge opposite the first edge, wherein the first edge has at least two bayonet grooves which are suitable for securing the securing part to the housing, wherein the bayonet grooves extend along the longitudinal axis and about the longitudinal axis transverse to the longitudinal axis, wherein the bayonet grooves each have an inlet, a ridge, a stop and a groove base with a groove depth, wherein the stop limits the bayonet grooves in their extension about the longitudinal axis, wherein the ridge is arranged on the groove base between the inlet and the stop and extends from the groove base radially relative to the longitudinal axis and at a predetermined height.

The invention relates to a securing part for a housing and a housing for a field device.

In analytical measurement technology, especially in the field of water industry, environmental analysis, in the industrial sector, e.g., in food technology, biotechnology, and pharmaceutics, and for a wide variety of laboratory applications, housings are used in order to reliably accommodate, for example, electronic components safe from environmental influences. Since maintenance or possibly a repair of the electronic components is to be guaranteed, a user must be able to open the housing. At the same time, however, it must also be possible to securely reclose the housing. For this purpose, the housing has a housing body and a cover. The cover is usually secured to the housing body by means of screws.

However, the use of screws has the disadvantage that the maintenance becomes more complicated, since the screws have to be removed individually using tools. In addition, removed screws can easily be lost, which causes an additional safety risk for the industrial installation on which the field device is used.

It is therefore an object of the invention to provide a housing for a field device which enables comfortable and reliable handling.

This object is achieved according to the invention by securing part for a housing according to claim 1.

The securing part according to the invention is ring-shaped and extends about a longitudinal axis. The securing part has a first edge and a second edge opposite the first edge. The first edge has at least two bayonet grooves which are suitable for securing the securing part to the housing. The bayonet grooves extend along the longitudinal axis and transversely relative to the longitudinal axis about the longitudinal axis. The bayonet grooves each have an inlet, a ridge, a stop and a groove base with a groove depth. The stop limits the bayonet grooves in their extension about the longitudinal axis. The ridge is arranged between the inlet and the stop on the groove base and extends from the groove base radially relative to the longitudinal axis at a predetermined height.

The securing part according to the invention makes it possible to provide a securing part for a housing which is convenient and reliable. The securing part does not have any screws, but rather allows the omission of separate closing means. In addition, the securing part is robust, since the retaining elements necessary for the closure are arranged in such a way that they cannot break off.

According to one embodiment of the invention, the ridge extends about the longitudinal axis and has a first ridge end and a second ridge end. The first ridge end has a first ridge bevel, and the second ridge end has a second ridge bevel.

According to one embodiment of the invention, the securing part comprises a resilient material.

According to one embodiment of the invention, the bayonet groove has a longitudinal groove and a transverse groove. The transverse groove extends parallel or obliquely to the first edge.

According to one embodiment of the invention, the bayonet grooves each define a center angle between 10° and 150° with the inlet and the stop on the longitudinal axis.

According to one embodiment of the invention, the securing part has at least one first bayonet groove and a second bayonet groove opposite the first bayonet groove on the securing part.

According to one embodiment of the invention, the second edge has a projection which extends radially to the longitudinal axis.

The aforementioned object is furthermore achieved by a housing for a field device according to claim 8.

The housing according to the invention comprises:
a securing part according to the invention,
a cylindrical housing body which extends about the longitudinal axis and has a housing edge which has at least two bayonet teeth which each extend radially to the longitudinal axis.

The bayonet teeth are each complementary to the bayonet grooves. The bayonet teeth have a first tooth end and a second tooth end. A first tooth bevel is arranged at the first tooth end and a second tooth bevel is arranged at the second tooth end and/or a first ridge bevel is arranged at the first ridge end and a second ridge bevel is arranged at the second ridge end or a first tooth bevel is arranged at the first tooth end and a second ridge bevel is arranged at the second ridge end or a first ridge bevel is arranged at the first ridge end and a second tooth bevel is arranged at the second tooth end. The ridges and the bayonet teeth are suitable for coming into contact with one another when the bayonet teeth are moved in the bayonet grooves.

According to one embodiment of the invention, the first tooth end and the second tooth end define a tooth length, and the second ridge end and the stop define a ridge-stop length. The tooth length and the ridge-stop length are identical, so that the bayonet tooth is suitable for engaging between the ridge and the stop.

According to one embodiment of the invention, the first ridge end and the second ridge end define a ridge length and the bayonet tooth has a recess which is arranged between the first tooth end and the second tooth end and has a recess length, wherein the recess length and the ridge length are identical, so that the ridge is suitable for engaging with the recess.

The invention is explained in more detail on the basis of the following description of the figures.

In the figures:

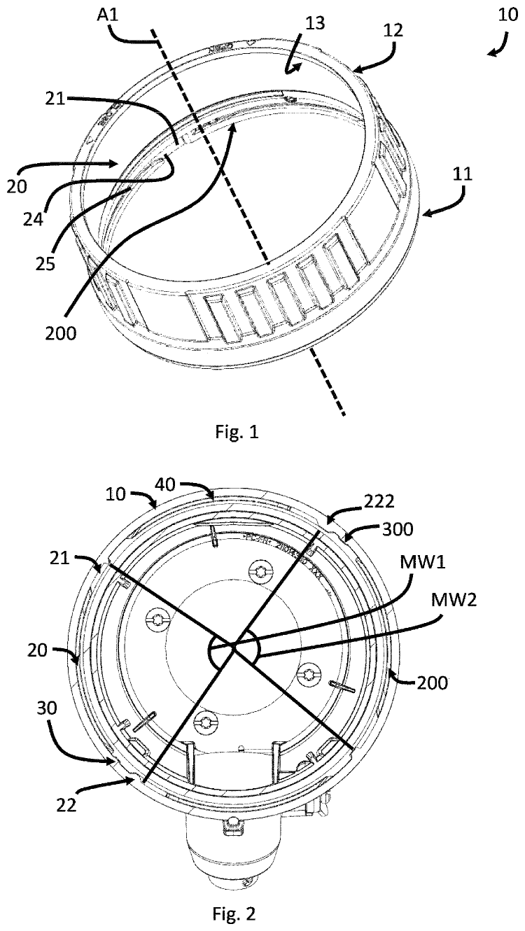

FIG. 1: shows a schematic diagram of the securing part according to the invention;

FIG. 2 shows a sectional view of a field device comprising a housing according to the invention and the securing part from FIG. 1;

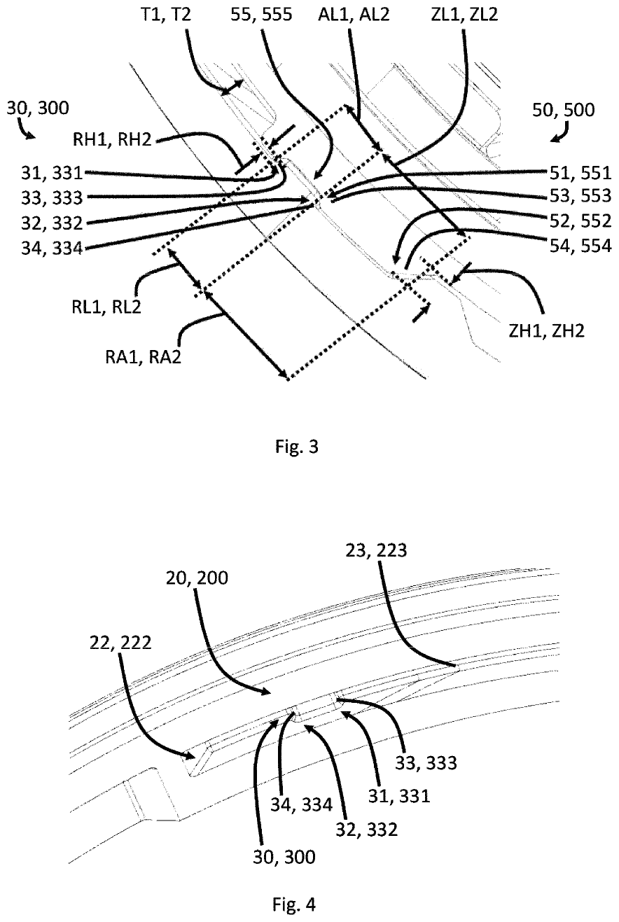

FIG. 3: shows an enlarged representation of a detail from FIG. 2 with the securing part and the housing;

FIG. 4: shows a perspective representation of a detail of the securing part from FIG. 3;

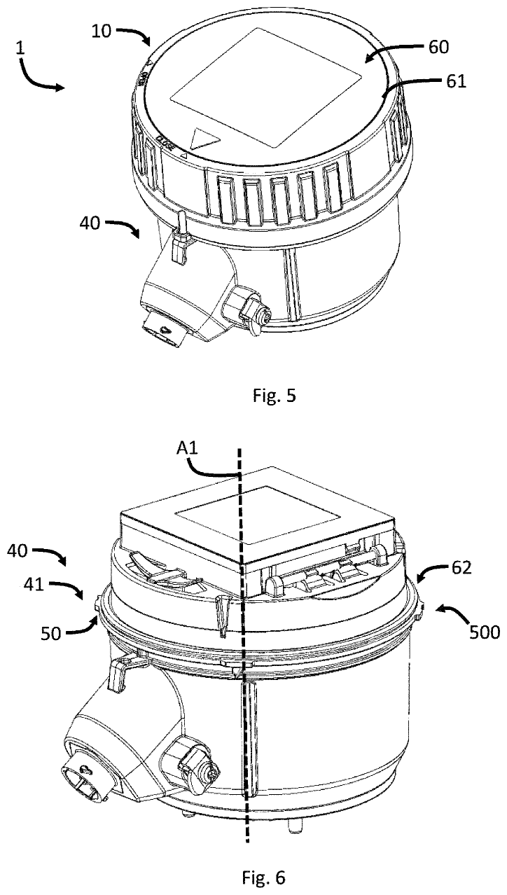

FIG. 5: shows a perspective representation of a field device comprising the securing part and the housing; and

FIG. 6: shows a perspective representation of a field device comprising the housing.

FIG. 1 shows a securing part 10 according to the invention for a housing 1 of a field device. An exemplary field device comprising the housing 1 and the securing part 10 is shown in FIG. 5.

The securing part 10 is ring-shaped or sleeve-shaped and extends about a longitudinal axis A1. The securing part 10 has a first edge 11 and a second edge 12 opposite the first edge 11. The first edge 11 has at least two bayonet grooves 20, 200, which are suitable for securing the securing part 10 to the housing 1. The second edge 12 preferably has a projection 13 which extends radially relative to the longitudinal axis A1. The projection 13 preferably extends toward the inside of the securing part 10, i.e., faces the longitudinal axis A1. The projection 13 is suitable for holding a cover 60 on the housing body 40. According to an alternative embodiment, the securing part 10 is pot-shaped so that the housing 1 is closed after connecting the securing part 10 and the housing body 40 (not shown). The securing part 10 is made of a resilient material, or comprises at least one resilient material, so that the securing part 10 is resiliently deformable. The securing part 10 is made of a plastic material, for example.

For the sake of simplicity, identical elements that occur more than once are described below only in the singular, even if several elements are meant. This is made clear by the use of several reference signs, e.g., 20 and 200.

The bayonet groove 20, 200 has an inlet 21, 221, a ridge 30, 300, a stop 22, 222, and a groove base 23, 223 having a groove depth T1, T2 (see FIG. 1 to FIG. 4).

The bayonet groove 20, 200 is preferably arranged on the inside of the securing part 10, i.e., facing the longitudinal axis A1. Of course, however, it is also alternatively possible to arrange the bayonet groove 20, 200 on the outside of the securing part 10, i.e., on a side of the securing part 10 facing away from the longitudinal axis A1. The bayonet groove 20, 200 extends along the longitudinal axis A1 and transversely relative to the longitudinal axis A1 about the longitudinal axis A1. As shown in FIG. 1, the bayonet groove 20, 200 has a longitudinal groove 24, 224 and a transverse groove 25, 225. The transverse groove 25, 225 extends parallel or obliquely to the first edge 11. A transverse groove 25 running obliquely to the first edge 11 has the advantage that when a sealing ring is arranged between the securing part 10 and a housing body 40, the sealing ring can be exposed to a contact pressure when the securing part 10 is secured to the housing body 40. The bayonet groove 20, 200 defines a center angle MW1, MW2 between 10° and 150° with the inlet 21, 221 and the stop 22, 222 on the longitudinal axis A1 (see FIG. 2). This means that if the bayonet groove 20, 200 extends only over a short portion along the securing part 10, for example, a portion which describes a central angle of 10°, a plurality of bayonet grooves can be attached to the securing part 10.

FIG. 2 shows an embodiment with two bayonet grooves 20, 200 which are arranged opposite to one another on the securing part 10.

The stop 22, 222 limits the bayonet groove 20, 200 in their extension about the longitudinal axis A1. The stop 22, 222 thus forms the end of the channel formed by the bayonet groove 20, 200. The stop 22, 222 forms a wall to the groove base 23, 223. The stop 22, 222 has, for example, a flank, which is shown in detail in FIG. 4. Alternatively, the stop 22, 222 is arranged, for example, 90° or at a different angle to the groove base 23, 223 (not shown).

The ridge 30, 300 extends about the longitudinal axis A1 and has a first ridge end 31, 331 and a second ridge end 32, 332 (see FIG. 4). The ridge 30, 300 is arranged between the inlet 21, 221 and the stop 22, 222 on the groove base 23, 223 (see FIG. 2). The ridge 30, 300 extends from the groove base 23, 223 radially relative to the longitudinal axis A1 with a predetermined ridge height RH1, RH2. The ridge height RH1, RH2 is lower than the groove depth T1, T2 of the bayonet groove 20, 200. The ridge height RH1, RH2 is, for example, between 1 mm and 5 mm. The first ridge end 31, 331 and the second ridge end 32, 332 define a ridge length RL1, RL2.

The first ridge end 31, 331 preferably has a first ridge bevel 33, 333 and the second ridge end 32, 332 preferably has a second ridge bevel 34, 334. The ridge bevels 33, 34, 333, 334 have, for example, an inclination between 10° and 60° relative to the groove base 23, 223.

The housing 1 comprises the securing part 10 described above and a cylindrical or pot-shaped housing body 40 (see FIG. 5).

The housing body 40 extends about the longitudinal axis A1 and has a housing edge 41 which has at least two bayonet teeth 50, 500 which each extend radially relative to the longitudinal axis A1 (see FIG. 6).

The bayonet tooth 50, 500 preferably extends away from the longitudinal axis A1, i.e., toward the outside of the housing body 40. The bayonet tooth 50, 500 has a tooth height ZH1, ZH2. The tooth height ZH1, ZH2 is preferably lower than the groove depth T1, T2. The bayonet tooth 50, 500 is designed such that it can be inserted into the bayonet groove 20, 200. When the bayonet groove 20, 200 is attached to the outside of the securing part 10, the bayonet tooth 50, 500 is aligned internally on the housing body 40, i.e., toward the longitudinal axis A1.

The bayonet tooth 50, 500 is complementary to the bayonet groove 20, 200. This means that the ridge 30, 300 and the bayonet tooth 50, 500 interlock such that the securing part 10 can be secured to the housing body 40. In other words, in a closed position, the securing part 10 can be held on the housing body 40 by the ridge 30, 300 and the bayonet tooth 50, 500. For this purpose, the bayonet tooth 50, 500 is inserted into the bayonet groove 20, 200 and moved to such an extent that the bayonet tooth 50, 500 and the ridge 30, 300 interlock.

The ridge 30, 300 and the bayonet tooth 50, 500 are suitable for coming into contact with one another when the bayonet tooth 50, 500 is moved relative to the ridge 30, 300 in the bayonet grooves 20, 200. When the bayonet tooth 50, 500 is moved relative to the ridge 30, 300, the bayonet tooth and the ridge may get caught. For this reason, it is advantageous to attach bevels to the bayonet tooth and/or on the ridge, which is explained below.

The bayonet tooth 50, 500 has a first tooth end 51, 551 and a second tooth end 52, 552. As can be seen in FIG. 3, according to one embodiment, a first tooth bevel 53, 553 is attached to the first tooth end 51, 551 and a second tooth bevel 54, 554 is attached to the second tooth end 52, 552. The tooth chamfers enable the ridge to be movable in the bayonet groove when the securing part 10 is moved as far as possible without getting caught relative to the bayonet tooth.

As can be seen in FIG. 3 and FIG. 4, according to an embodiment which is compatible with the above-mentioned embodiments, a first ridge bevel 33, 333 is arranged at the first ridge end 31, 331 and a second ridge bevel 34, 334 is arranged at the second ridge end 32, 332. If, in addition to the bayonet tooth, the ridge has ridge bevels, getting caught between the ridge and the bayonet tooth can be avoided.

It is thus advantageous if either the ridge has two ridge bevels or the bayonet tooth has two tooth bevels. Ideally, the ridge has two ridge bevels, and the bayonet tooth has two tooth bevels.

According to an alternative embodiment, the bayonet tooth 50, 500 has a first tooth bevel 53, 553 at the first tooth end 51, 551 and the ridge 30, 300 has a second ridge bevel 34, 334 at the at the second ridge end 32, 332. Thus, in the case of a relative movement between ridge 30, 300 and bayonet tooth 50, 500, at least one bevel is present in both directions of movement along the bayonet groove 20, 200, which bevel prevents the ridge 30, 300 and the bayonet tooth 50, 500 from getting caught.

According to an alternative embodiment, the ridge 30, 300 has a first ridge bevel 33, 333 at the first ridge end 31, 331 and the bayonet tooth 50, 500 has a second tooth bevel 54, 554 at the second tooth end 52, 552. Thus, in the case of a relative movement between ridge 30, 300 and bayonet tooth 50, 500, at least one bevel is present in both directions of movement along the bayonet groove 20, 200, which bevel prevents the ridge 30, 300 and the bayonet tooth 50, 500 from getting caught.

The interaction between bayonet groove 20, 200 and bayonet tooth 50, 500 is shown in detail In FIG. 3.

The first tooth end 51, 551 and the second tooth end 52, 552 define a tooth length ZL1, ZL2. The second ridge end 32, 332 and the stop 22, 222 define a ridge-stop length RA1, RA2. The tooth length ZL1, ZL2 and the ridges-stop length RA1, RA2 are preferably identical, so that the bayonet tooth 50, 500 is suitable for engaging between the ridge 30, 300 and the stop 22, 222.

According to an optional embodiment, which is shown in FIGS. 2, 3 and 6, and is compatible with all described embodiments, the bayonet tooth 50, 500 has a recess 55, 555 which is arranged between the first tooth end 51, 551 and the second tooth end 52, 552. The recess 55, 555 has a recess length AL1, AL2. The recess length AL1, AL2 and the ridge length RL1, RL2 are preferably identical, so that the ridge 30, 300 is suitable for engaging with the recess 55, 555.

As can be seen in FIG. 5, the housing 1 furthermore optionally has a cover 60 which is suitable for being secured to the housing body 40 by means of the securing part 10. The cover 60 has an edge 61 which is suitable for engaging in the projection 13 of the securing part 10. This allows the cover 60 to be secured to the housing body 40 by the securing part 10. A seal 62, for example a sealing ring, is preferably arranged between the cover 60 and the housing body 40. When the securing part 10 is connected to the housing body 40, a pressing force is exerted by the securing part 10 on the cover 60 thanks to the oblique bayonet groove 20, 200, which pressing force presses the sealing ring.

In an alternative embodiment, the securing part 10 is integrally formed with the cover 60 (not shown).

### LIST OF REFERENCE SIGNS

1 Housing

10 Securing part

11 First edge

12 Second edge

13 Projection

20 First bayonet groove

21 Inlet

22 Stop

23 Groove base

24 Longitudinal groove

25 Transverse groove

30 Ridge

31 First ridge end

32 Second ridge end

33 First ridge bevel

34 Second ridge bevel

40 Housing body

41 Housing edge

50 First bayonet tooth

51 First tooth end

52 Second tooth end

53 First tooth bevel

54 Second tooth bevel

55 Recess

60 Cover

61 Edge

62 Seal

200 Second bayonet groove

221 Inlet

222 Stop

223 Groove base

224 Longitudinal groove

225 Transverse groove

300 Ridge

331 First ridge end

332 Second ridge end

333 First ridge bevel

334 Second ridge bevel

500 Second bayonet tooth

551 First tooth end

552 Second tooth end

553 First tooth bevel

554 Second tooth bevel

555 Recess

A1 Longitudinal axis

AL1, AL2 Recess length

MW1, MW2 Center angle

RL1, RL2 Ridge length

RH1, RH2 Ridge height

T1, T2 Groove depth

ZL1, ZL2 Tooth length

ZH1, ZH2 Tooth height
1-10. (Canceled)

11. A securing part for a housing, wherein the securing part is ring-shaped and extends about a longitudinal axis, the securing part comprising:
a first edge and a second edge opposite the first edge,
wherein the first edge includes at least two bayonet grooves which are configured to secure the securing part to the housing,
wherein the at least two bayonet grooves extend along the longitudinal axis and transversely relative to the longitudinal axis about the longitudinal axis,
wherein the at least two bayonet grooves each have an inlet, a ridge, a stop, and a groove base having a groove depth,
wherein each stop is configured to limit the respective bayonet groove in its extension about the longitudinal axis, and
wherein each ridge is arranged between the respective inlet and the respective stop on the groove base and extends from the groove base radially relative to the longitudinal axis at a predetermined height.

12. The securing part according to claim 11, wherein each ridge extends about the longitudinal axis between a first ridge end and a second ridge end, and
wherein the first ridge end includes a first ridge bevel, and the second ridge end includes a second ridge bevel.

13. The securing part according to claim 11, wherein the securing part comprises a resilient material.

14. The securing part according to claim 11, wherein each bayonet groove includes a longitudinal groove and a transverse groove, wherein the transverse groove extends parallel or obliquely to the first edge.

15. The securing part according to claim 11, wherein the at least two bayonet grooves each define a central angle between 10° and 150° with the respective inlet and the respective stop on the longitudinal axis.

16. The securing part according to claim 11, wherein the securing part includes at least one first bayonet groove and a second bayonet groove opposite the first bayonet groove on the securing part.

17. The securing part according to claim 11, wherein the second edge includes a projection, which extends radially relative to the longitudinal axis.

18. A housing for a field device, the housing comprising:
the securing part according to claim 11; and
a cylindrical housing body, which extends about the longitudinal axis and includes a housing edge, which includes at least two bayonet teeth, which each extend radially relative to the longitudinal axis,
wherein the at least two bayonet teeth are each complementary to the at least two bayonet grooves,
wherein the at least two bayonet teeth each include a first tooth end and a second tooth end,
wherein a first tooth bevel is arranged at the first tooth end and a second tooth bevel is arranged at the second tooth end, and/or a first ridge bevel is arranged on the first ridge end and a second ridge bevel is arranged on the second ridge end, or
wherein a first tooth bevel is arranged at the first tooth end and a second ridge bevel is arranged on the second ridge end, or a first ridge bevel is arranged on the first ridge end and a second tooth bevel is arranged at the second tooth end,
wherein the ridges and the bayonet teeth are configured for coming into contact with each other when the bayonet teeth are moved in the bayonet grooves.

19. The housing according to claim 18, wherein the first tooth end and the second tooth end define a tooth length, and the second ridge end and the stop define a ridge-stop length, and
wherein the tooth length and the ridge-stop length are identical such that the bayonet tooth is operable to engage between the ridge and the stop.

20. The housing according to claim 18, wherein the first ridge end and the second ridge end define a ridge length, and the bayonet tooth includes a recess which is arranged between the first tooth end and the second tooth end and has a recess length,
wherein the recess length and the ridge length are identical such that the ridge is operable to engage with the recess.
